(19) United States
(12) Patent Application Publication
(10) Pub. No.: US 2009/0116130 A1
(43) Pub. Date: May 7, 2009

(54) Assemblage And Method For Connecting An Optical First Component To A Second Component

(76) Inventors: Jens Schick, Herrenberg (DE); Gerald Franz, Backnang (DE)

Correspondence Address: KENYON & KENYON LLP, ONE BROADWAY, NEW YORK, NY, 10004, US

(21) Appl. No.: 11/792,014

(22) PCT Filed: Oct. 20, 2005
(86) PCT No.: PCT/EP05/55411

§ 371 Date: Apr. 4, 2008

(30) Foreign Application Priority Data
Nov. 30, 2004 (DE) 10 2004 057 691.2

(51) Int. Cl. G02B 7/02

(52) U.S. Cl. 359/819; 29/428

(57) ABSTRACT

For an assemblage and a method for connecting an optical first component to a second component, provision is made that at least two annular fitting parts, whose thickness proceeds in wedge-shaped fashion, are retained between a respective support surface on the first and on the second component, the fitting parts being located with respect to one another, in terms of their rotation and their displacement, in such a way that the first and the second component assume a predetermined position with respect to one another.

### FIELD OF THE INVENTION

The present invention relates to an assemblage for connecting an optical first component to a second component, and to methods for manufacturing the assemblage.

### BACKGROUND INFORMATION

When connecting an optical component, for example an objective, to a further component, for example an image sensor, an exact correlation of the two components is necessary in order to achieve perfect optical function. A compensation for insufficient precision of the components themselves, or of their mounts, is necessary.

### SUMMARY OF THE INVENTION

It is an object of the invention to overcome the aforesaid difficulties in simple fashion, and to create a robust, long-lasting connection of the components.

This object is achieved, in the context of the assemblage according to the exemplary embodiment and/or exemplary method of the present invention, in that at least two annular fitting parts, whose thickness proceeds in wedge-shaped fashion, are retained between a respective support surface on the first and on the second component, the fitting parts being located with respect to one another, in terms of their rotation and their displacement, in such a way that the first and the second component assume a predetermined position with respect to one another.

With the assemblage according to the exemplary embodiment and/or exemplary method of the present invention, connection is achieved without the use of adhesives, with the result that the dimensional accuracy of the previous alignment is retained despite aging and environmental influences. Inexpensive standardized fitting parts, which are notable for high rigidity, can be used. In addition, it is easily possible to align and install the assemblage according to the exemplary embodiment and/or exemplary method of the present invention. Because a uniform material is used, a long service life can be achieved even under extreme climatic conditions.

By rotation of the two annular fitting parts, any desired inclinations between zero and twice the angle respectively enclosed by a fitting part can be set. The distance between the two components to be connected can be mutually adjusted by lateral displacement of the fitting parts.

An example of application of the assemblage according to the exemplary embodiment and/or exemplary method of the present invention involves the fact that the first component is an objective and the second component is an image sensor. Application of the invention is not, however, limited thereto, but can be effected for all components that are connected in a manner exactly aligned with one another.

An exemplary embodiment of the invention involves the fact that flanges, which are clamped against one another with the aid of screws, are provided for retaining the fitting parts. Clamping with the aid of screws has proven advantageous. Other possibilities, however, for example using resilient clamps, are also suitable in principle.

In a refinement of the invention, a hermetic closure of the installation space between the two components is achieved by the fact that the fitting parts form, at least in part, the side walls of a closed space between the first and the second component. Shielding for EMC protection is thereby achieved.

Provision may be made, in the context of the assemblage according to the exemplary embodiment and/or exemplary method of the present invention, for the fitting parts to be made of metal. Metals suitable in terms of stability and service life, as well as resistance to environmental influences, are available to one skilled in the art. The assemblage according to the exemplary embodiment and/or exemplary method of the present invention can be equipped if necessary, especially externally, with paint or with another suitable coating.

Depending on the specific application instance, provision can be made in the context of the assemblage according to the exemplary embodiment and/or exemplary method of the present invention for the annular fitting parts to have a circular shape externally. Other shapes for the fitting parts, for example rectangular ones, are also possible if necessary.

If the assemblage according to the exemplary embodiment and/or exemplary method of the present invention is not also surrounded by an external housing, but the fitting parts instead form at least a portion of the housing, provision can be made in the context of the assemblage according to the exemplary embodiment and/or exemplary method of the present invention for the number and the wedge angle of the fitting parts to be selected to be sufficiently large that a requisite adjustment range is ensured with no disruptive influence on the external shape of the totality of the fitting parts.

In a context of larger wedge angles in particular, it may be advantageous if contact surfaces of the fitting parts are structured in order to enhance adhesion.

The invention furthermore encompasses a method for manufacturing an assemblage for connecting an optical first component to a second component, at least two annular fitting parts, whose thickness proceeds in wedge-shaped fashion, being retained between a respective support surface on the first and on the second component, the fitting parts being located with respect to one another, in terms of their rotation and their displacement, in such a way that the first and the second component assume a predetermined position with respect to one another, in which method provision is made that the components are brought, by way of a suitable manipulator, into a first position with respect to one another, support surfaces provided for the annular fitting parts being pressed with predetermined forces onto one another; that the coordinates of the first position are stored; that the two components are brought into a second position that is optimal in terms of a desired optical effect; that a rotation and a lateral displacement of the fitting parts are calculated from the differences of the positions; and that the fitting parts are placed, in consideration of the calculated lateral displacement and rotation, between the components and retained.

These method steps can be largely automated, thus ensuring cost-effective manufacture of the assemblage according to the exemplary embodiment and/or exemplary method of the present invention.

In another method for manufacturing an assemblage according to the exemplary embodiment and/or exemplary method of the present invention, provision is made that for manufacturing the fitting parts, two carriers, which each have a plane surface, which assume an angle corresponding to the thickness profile of one fitting part; that at those locations on the surface that correspond to the support surfaces of the fitting parts to be manufactured, a respective metal layer is deposited; that the metal layers are joined to one another by the application of further metal; and that the resulting fitting part is detached from the surfaces of the two carriers.

This method makes possible cost-effective and precise manufacture of the fitting parts, the precision in terms of planarity, fits, and surface roughness being transferred from the tool, once it is manufactured, to the fitting parts. Suitable materials for the carriers are, for example, glass ceramic, glass, or ceramic. The carriers can be strip-shaped so that multiple fitting parts can be manufactured alongside one another. The contact surfaces of the fitting parts are deposited, as metal mirrors, by evaporation (sputtering or vacuum evaporation). Materials suitable for this are, for example, copper, nickel, or silver. In a further process step, the evaporated contact surfaces of the fitting parts are electrolytically reinforced until a thickness of approximately 0.1 mm is reached. The same materials are appropriate in this context.

In a third process step, the upper and lower contact surfaces of the fitting parts are joined to one another. According to a first embodiment of the method, this can be effected by the fact that joining of the metal layers is accomplished by immersion into a solder bath.

A second embodiment involves the fact that for joining of the two metal layers, an intermediate piece having lesser requirements in terms of dimensional accuracy is placed between the metal layers, and the metal layers are joined to the intermediate piece by immersion into a solder bath.

In a third embodiment, provision is made that the metal layers are first electrolytically reinforced, and the reinforced metal layers are joined conductively to one another and immersed as a cathode into an electrolysis bath until the space between the metal layers is filled with metal.

### BRIEF DESCRIPTION OF THE DRAWINGS

FIG. 1 schematically depicts an assemblage according to the exemplary embodiment and/or exemplary method of the present invention.

FIG. 2 shows the geometric relationships and dimensions in the context of execution of the method according to the present invention.

FIG. 3 shows an apparatus for carrying out the further method according to the present invention.

### DETAILED DESCRIPTION

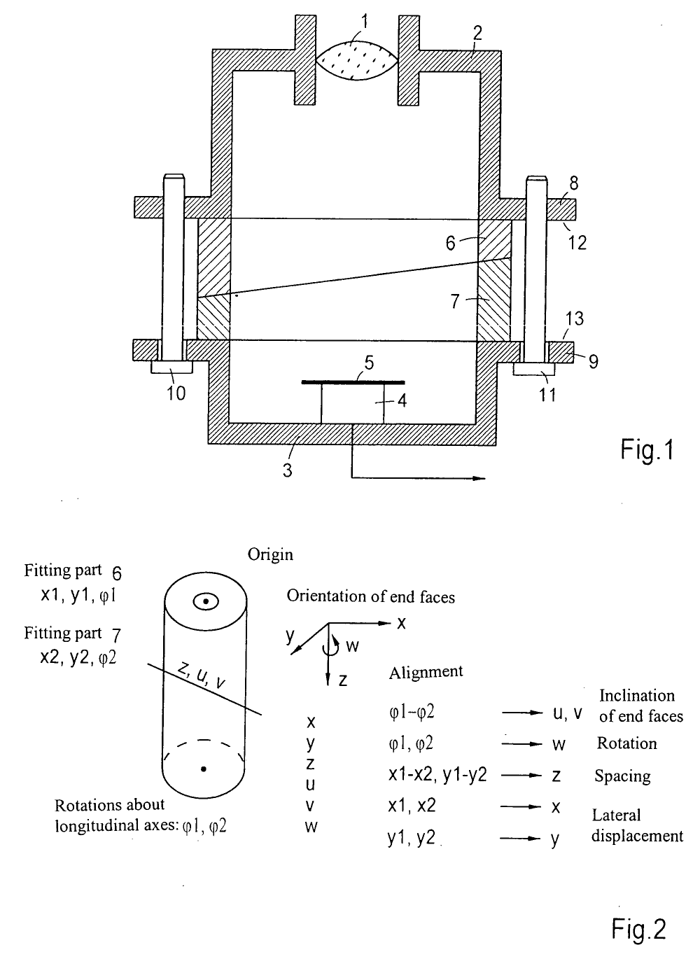

FIG. 1 schematically depicts, in section, a video camera as used, for example, for optical sensors in automotive engineering. An objective 1, which is depicted schematically as made up of one lens, is held in a mount 2 that is at the same time a first housing part. A second housing part 3 carries, on a cooling element 4, a semiconductor image sensor 5 on which the scene to be acquired is imaged with the aid of objective 1.

Provided for adjustment of the correct position of objective 1 and image sensor 5 are two fitting parts 6, 7 that are retained between the two housing parts 2, 3 with the aid of two flanges 8, 9 and screws 10, 11 distributed on the periphery. The thickness of fitting parts 6, 7 has a wedge-shaped profile, so that by rotation and displacement of the fitting parts with respect to one another, housing parts 2, 3, and thus objective 1 and image sensor 5, can be tilted with respect to one another and their spacing can be adjusted.

A method for manufacturing an assemblage according to the invention will be explained below with reference to the magnitudes depicted in FIG. 2. Firstly housing part 2 is retained. Housing part 3 is grasped by a manipulator. The latter has six degrees of freedom, and is therefore also referred to as a hexapod. The manipulator moves housing part 3 toward housing part 2 so that support surfaces 12, 13 rest on one another and are pressed onto one another with a predetermined force. An initialization follows, by the fact that the coordinates x, y, and z are stored.

Housing part 3 is then moved by the manipulator until it is in a position in which image sensor 5 yields an optimum image quality. Coordinates x, y, z, u, v, w are thus known. A suitable measuring arrangement is made available for measuring image quality.

The locations of the two fitting parts 6 and 7 are calculated from the coordinates of the optimum position, namely x1, y1, φ1, x2, y2, and φ2. The two fitting parts 6 and 7 are fitted together, u and v being adjusted by rotation of fitting parts 5, 6 with respect to one another about φ1−φ2. When u and v fall below a limit value, an undersize for the height h1+h2 of the sum of the two fitting parts 6, 7 is set, permitting reliable assembly.

The two fitting parts are then aligned, for assembly, in the displacement direction (φ1, φ2). The oriented pair of fitting parts is brought into a shifting position and, for assembly, shifted between oriented parts 2, 3. For sufficiently large values of u, v, the pair of fitting parts 6, 7 is then shifted between housing parts 2, 3 until the forces exceed a predetermined threshold. A sealing by way of the surface contact is then accomplished. If u, v are too small, the undersize that was set must be corrected, by lateral displacement in opposite directions, until the forces exceed the respective predetermined threshold.

Housing parts 2 and 3 are then bolted to one another so that the respective forces fall just below a predetermined low threshold. Dimensional accuracy is thus achieved due to absence of forces.

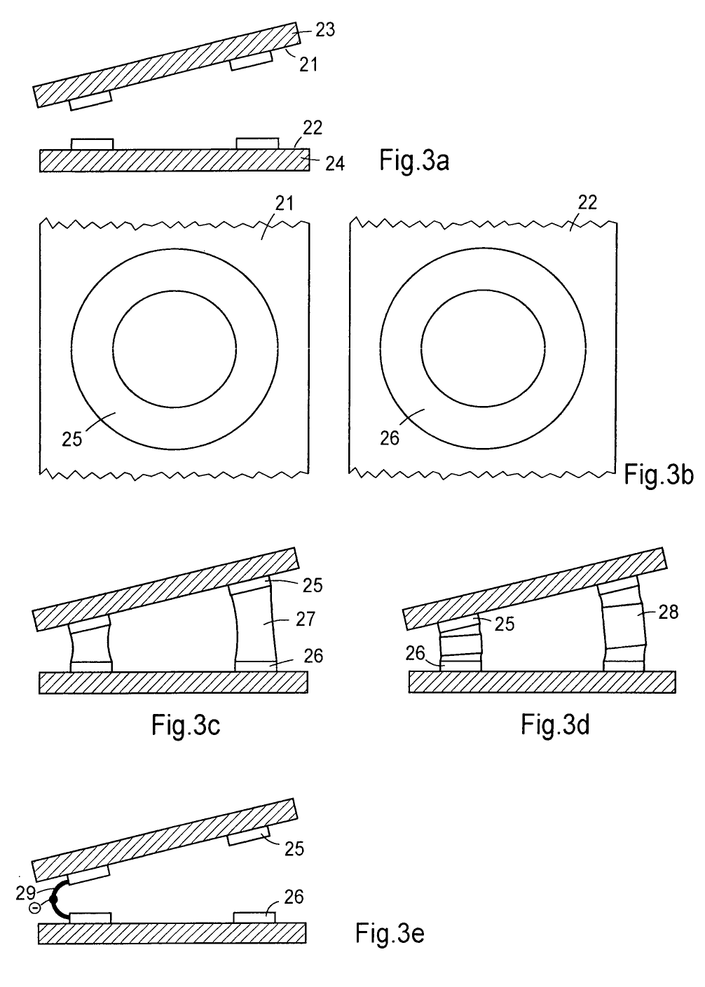

FIG. 3 serves to explain various methods for manufacturing the fitting parts, two plane surfaces 21, 22 forming in each case a surface corresponding to the wedge angle. In a first step, the contact surfaces of the fitting parts are applied onto surfaces 21, 22 of carriers 23, 24 (FIG. 3a) so that a ring (FIG. 3b) made up of a metallic layer 25, 26 is created on each surface 21, 22. In further process steps, the two carriers 23, 24 having the two metal layers 25, 26 are immersed into a solder bath. With appropriate process management, metal layers 25 and 26 are joined to one another so that after the solder is hardened by heating carriers 23, 24, the finished fitting part 27 can be detached (FIG. 3c).

In the second variant according to FIG. 3d, a coarsely machined intermediate part 28, whose dimensional accuracy is subject to lesser requirements and which can therefore be manufactured as a stamped part, is placed between metal layers 25, 26 prior to immersion into a solder bath. After introduction into the solder bath, the process steps that occur are the same as in the first variant.

A third variant (FIG. 3e) involves the fact that the two metal layers 25, 26 are contacted as a common cathode 29, and immersed again into the electrolysis bath. With suitable process management and with a sufficiently slow deposition rate, the two metal layers 25, 26 are electrolytically joined to one another. After complete joining of the upper and lower sides, the fitting parts are detached, by heating, from carriers 23.

1-13. (canceled)

14. An assemblage for connecting an optical first component to a second component, comprising:
at least two annular fitting parts, whose thickness proceeds in wedge-shaped fashion, and which are retained between a respective support surface on the first component and on the second component, the at least two annular fitting parts being located with respect to one another, in terms of their rotation and their displacement, so that the first component and the second component assume a predetermined position with respect to one another.

15. The assemblage of claim 14, wherein the first component is an objective and the second component is an image sensor.

16. The assemblage of claim 14, further comprising:
flanges, which are clamped against one another with the aid of screws, for retaining the at least two annular fitting parts.

17. The assemblage of claim 14, wherein the at least two annular fitting parts form, at least in part, side walls of a closed space between the first component and the second component.

18. The assemblage of claim 14, wherein the at least two annular fitting parts are made of metal.

19. The assemblage of claim 14, wherein the at least two annular fitting parts have a circular shape externally.

20. The assemblage of claim 14, wherein a number and the wedge angle of the at least two annular fitting parts are selected to be sufficiently large so that a requisite adjustment range is ensured with no disruptive influence on an external shape of a totality of the at least two annular fitting parts.

21. The assemblage of claim 14, wherein contact surfaces of the at least two annular fitting parts are structured to enhance adhesion.

22. A method for manufacturing an assemblage for connecting an optical first component to a second component, the method comprising:
providing at least two annular fitting parts, whose thickness proceeds in wedge-shaped fashion, and retaining them between a respective support surface on the first and on the second component, the fitting parts being located with respect to one another, in terms of their rotation and their displacement, so that the first component and the second component assume a predetermined position with respect to one another;
bringing the at least two annular components by a manipulator into a first position with respect to one another, and pressing support surfaces, provided for the at least two annular fitting parts, with predetermined forces onto one another;
storing coordinates of the first position stored;
bringing the first and second components into a second position that is optimal in terms of a desired optical effect;
determining a rotation and a lateral displacement of the fitting parts from differences of the positions; and
placing the at least two annular fitting parts, in consideration of the determined lateral displacement and rotation, between the first and second components so that they are retained.

23. A method for manufacturing an assemblage for connecting an optical first component to a second component, the method comprising:
providing at least two annular fitting parts, whose thickness proceeds in wedge-shaped fashion, and retaining them between a respective support surface on the first and on the second component, the fitting parts being located with respect to one another, in terms of their rotation and their displacement, so that the first component and the second component assume a predetermined position with respect to one another,
wherein the fitting parts are made using two carriers each have a plane surface and which assume an angle corresponding to a thickness profile of one of the fitting parts;
depositing at those locations on a surface that corresponds to the support surfaces of the fitting parts to be made, a respective metal layer;
joining the metal layers to one another by the application of a further metal; and
detaching a resulting fitting part from the surfaces of the two carriers.

24. The method of claim 23, wherein the metal layers are joined by immersion in a solder bath.

25. The method of claim 23, wherein for the joining of the two metal layers, an intermediate piece having lesser requirements in terms of dimensional accuracy is placed between the metal layers, and the metal layers are joined to the intermediate piece by immersion into a solder bath.

26. The method of claim 23, wherein the metal layers are first electrolytically reinforced, and the reinforced metal layers are joined conductively to one another and immersed as a cathode into an electrolysis bath until the space between the metal layers is filled with metal.
